(19) United States
(12) Patent Application Publication
(10) Pub. No.: US 2006/0169013 A1
(43) Pub. Date: Aug. 3, 2006

(54) Ring key

(76) Inventors: William John Haslem, Loudon, TN (US); Kenneth Henry Dunn, Lighthouse Point, FL (US)

Correspondence Address: Kenneth H. Dunn, 5010 NE 22 AVE., Lighthouse Point, FL, 33064, US

(21) Appl. No.: 11/047,046

(22) Filed: Feb. 1, 2005

(51) Int. Cl. E05B 63/22; A45C 11/32; A47G 29/10; A44B 15/00

(52) U.S. Cl. 70/456 R; 70/387

(57) ABSTRACT

When designing a firearm it became very apparent that a firearm locking system would be needed for the prevention of unauthorized use of the weapon such as children and others. This system had to be used for Citizens, Police, Military, and Government users in their bedroom, on duty, and for its fast access time, (less than 2 seconds) safety, and quality, reliability, must be built and made with the highest performance of design, testing, manufacturing, to build and sell a superior product.

### BACKGROUND OF INVENTION

The way locks are presently unlocked today are: Locks with a key, combination of numbers, sequence of push buttons etc, etc. The access to lthe lock unlocked was time consuming especially in an emergency. It would be profoundly safer to user to have visual sighting of the key at all time to access the lock more swiftly and to know that when the user returns key to the visual location it is locked with great assurance and security. User can then communicate this highly secure condition as to what was locked to anyone of necessary authority. To have a key always visible to the user the user knows at all times, for example, the firearm is locked, his ATM card is unavailable to anyone else. In short, a persons key which accesses their valuables is in plain sight as it is worn on their finger as any other ring.

### PRIOR STATE OF THE ART

To locate your keys in a purse, pocket or any other place takes a longer time than is necessary especially if one is getting into their vehicle in a dark parking lot etc. etc. Keys have very poor access speed (time) as you must remember where you left them and of course you must be prompt to put the key in the lock when stalked in a dangerous area. Also remembering the sequence of numbers is a greater risk than a key on a ring that one may carry.

### SUMMARY OF INVENTION

Ring Key solves all the problems of other types of keys and locks by having the Ring Key made to open one's door, lock ones firearm, unlock one's auto lock, one's safe and even use the Ring Key to access an ATM by and or, both magnetic media, lasered media, permanent or re-writable data encripted for entry identification, authorization, and the use of certain ‘strategic systems’ that are vital to our contries defenses in many ways.

### BRIEF DESCRIPTION OF DRAWINGS

FIG. 1. Is the Ringkey placed into the Ringlock. The outside surface of the Ringkey contacts the wafers of the Ringlock depressing the wafers which then present a aligned opening on the wafers to permit entrance of the trigger block into the aligned opening so, in the present example, the gun is enabled to fire as the trigger block no longer blocks the trigger from being pressed to fire the gun.

FIG. 2. Is a top view of the Ringkey inserted into the Ringlock.

FIG. 3. Is a ½ sectioned top view of the Ringkey showing the outside circumference wafer contacting ridges and the Ringkeys inside circumference whereupon laser encripted code placement is located.

FIG. 4. Is a top view of the Ringlock.

### DESCRIBE THE DRAWINGS BELOW

FIG. 1. of pg. 1 is a side view of the Ringkey lock installed over a trigger of a firearm.

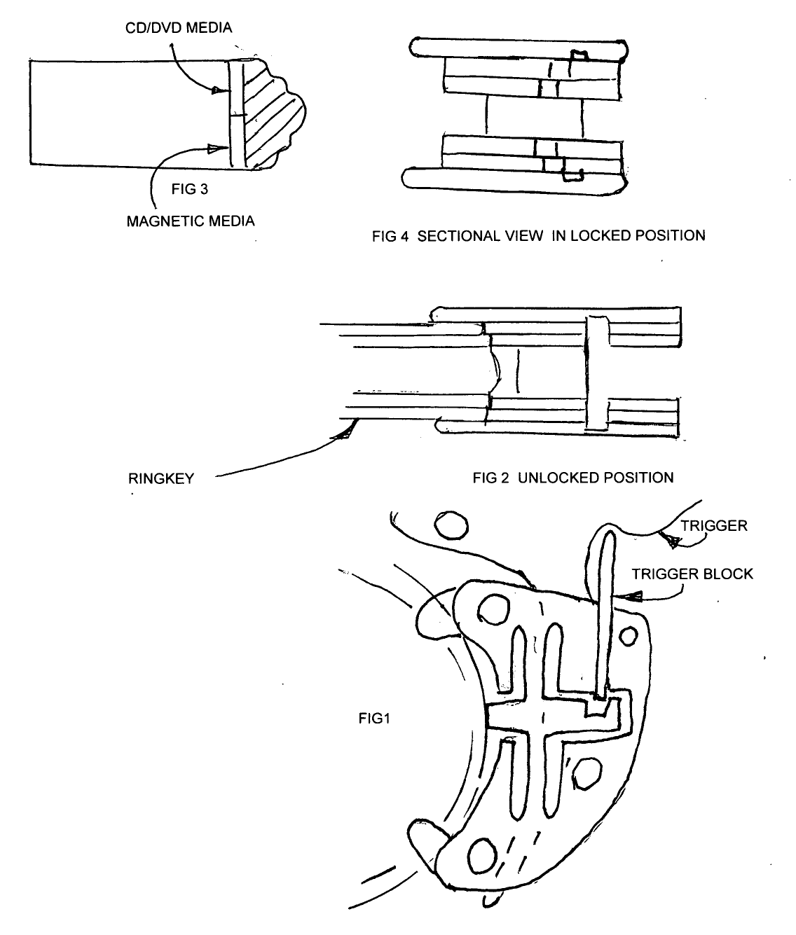

FIG. 2. of pg. 1 is the top view of FIG. 1.

FIG. 3. is a sectional view of the Ringkey showing the area where magnetic or laser data can be applied to use for many other identification purposes etc, Ringkey is in the locked position.

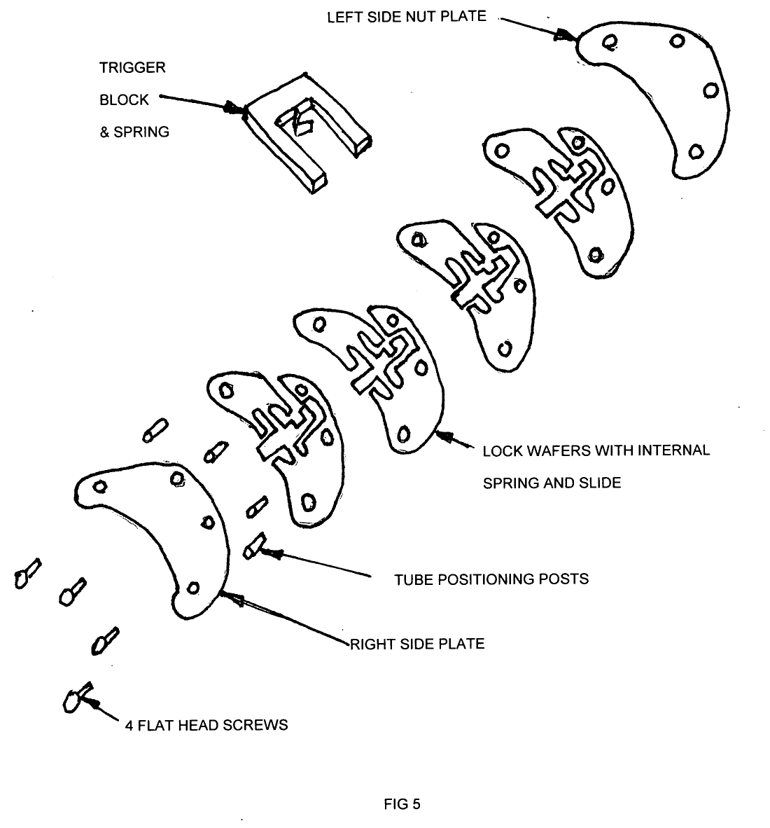

FIG. 4. is the sectional view of the Ringkey lock in the locked position. (this automatically functions when the Ringkey is removed from the Ringkey Lock that is installed on the trigger of a firearm or any other triggered device.)

FIG. 5. is an exploded view of all the parts with the least amount of wafers in the Ringkey Lock.

1. Ringkey and Ringkey lock, which can be made of metalic, nonmetalic and non-conductive materials, functions when the Ringkey is inserted into the Ringlock to align the locking wafers of the Ringlock which unblock blocking of locking bar to open lock thereby enabling the use of the locked device. To relock device remove Ringkey from Ringlock and replace Ringkey on finger where Ringkey is plainly visible for easy and fast access with the additional assurance that the locked device is locked because of the known location of the Ringkey as Ringkey is worn on any finger.

2. The Ringkey and Ringkey lock, because of it's simplicity of function and design in respect to overall security in any application ie, firearms, safes, doorknobs, automobile locks, padlocks, etc, etc compared to the present state of the art is especially unique because coded magnetic or CD, DVD, Laser encription placed on the inner diameter of the Ringkey for strategic locking requirements, ie government, banks, and replacement of ATM card devices because the location of the Ringkey device is plainly visible as it is worn on the finger and such placement of encription, as forestated, is protected against physical damage as the inner surface diameter of the Ringkey is safely against the finger, therefore, the mechanically functional aspect of the outer diameter of the Ringkey is supplimented by the coded electronic functionality of the inner surface of the Ringkey all of which can be used separately or in unison.
